(19) United States
(12) Patent Application Publication
(10) Pub. No.: US 2007/0230298 A1
(43) Pub. Date: Oct. 4, 2007

(54) Spiral Angle Controlled Information

(75) Inventors: Adrianus Johannes Maria Denissen, Eindhoven (NL); Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,547

(22) PCT Filed: Apr. 28, 2005
(86) PCT No.: PCT/IB05/51384

§ 371 Date: Nov. 1, 2006

(30) Foreign Application Priority Data
May 6, 2004 (EP) 04101951.4

(51) Int. Cl. G11B 20/00

(52) U.S. Cl. 369/47.1

(57) ABSTRACT

A device, multilayer record carrier and method are given for providing information in a controlled way. The multilayer record carrier has spiral angle information to be applied and/or verified while accessing the content of the record carrier. Thereto a spiral angle (55) between two data layers of the multilayer record carrier is detected. The spiral angle indicates an actual rotational angle between a first predetermined location (51) on the first data layer (40) and a second predetermined location (52) on the second data layer (41). The spiral angle information and the spiral angle for controlling are combined for controlling said providing of information, e.g. for copy protection, various versions of software or for providing a parameter to identify the record carrier.

The invention relates to a method of providing information via a multilayer record carrier, the record carrier comprising at least a first data layer and a second data layer.

The invention further relates to a multilayer record carrier for providing information, the record carrier comprising at least a first data layer and a second data layer.

The invention further relates to a computer program product for providing information.

The invention further relates to a device for scanning the multilayer record carrier via a beam of radiation for providing information, the device comprising, scanning means for recording and/or retrieving the information, which scanning means include a head for providing the beam of radiation.

In particular the invention relates to the field of controlling access of a user to information provided on optical discs, e.g. for copy protection. For over 20 years now, commercial software for PCs or PC-like platforms like MS XBox, Sony PlayStation, Sega DreamCast, Nintendo GameCube has been distributed on cheap, easy to reproduce media: first floppy discs, and more recently optical media. There are many methods, known from prior art, to protect this software from being copied illegally, e.g. dongles, running on remote servers etc. A cheap and most widely used method is to alter the distribution media in such a way that this alteration cannot be reproduced (easily) in writers available to the public. The alteration should be detectable using ordinary playback-drives. Examples are: holes in the physical media (manifests themselves through error bursts in pre-determined locations), intentional errors in ECC-parities, (manifests themselves through error bursts in pre-determined locations), data written to lead-in sectors on DVD (reading is supported on DVD-ROM drives, but writing not generally on DVD-writers), essential data written in sub-channels (like the sub-channels R-W of a CD), optical discs with multiple sessions which are not written according to specification (presumably a writer can only write data according to specifications). These alterations are sometimes referred to collectively as ROM side-channels. Upon execution, the software present in the PC or PC-like platform checks whether the required alteration is present on the media, and if not, it terminates because presumably it was running from an illegal copy.

An example of such a side-channel for copy protection purposes of optical record carriers is based on additional physical marks on the optical disc. U.S. Pat. No. 6,470,452 discloses a copy protection mechanism which is based on measuring, on a record carrier like CD or DVD, the relative position of specific non-reflective areas. The non-reflective areas are created by removing the aluminum reflective layer from the data layer on selected spots by a powerful laser. When applied to a multilayer record carrier such non-reflective areas are created on both layers on substantially the same location. A barcode is added to the record carrier to indicate the positions of the non-reflective areas. Illegal copying is prevented, by comparing the indicated position of the non reflective areas on an original record carrier with the measured orientation of an alleged pirate copy.

A disadvantage of the known method is that the non-reflective areas have to be created by an additional step during manufacture using the high-power laser at a high positional accuracy. In addition the device has to be able to detect special deviating reflection levels of such areas, which requires additional hardware circuits to detect the difference between usual high and low scanning signal levels and the lower scanning signal level at the non-reflective areas.

Therefore it is an object of the invention to provide a system of providing information in a controlled way via a record carrier in which no additional reflection levels need to be detected.

According to a first aspect of the invention the object is achieved with a method of providing information via a multilayer record carrier as described in the opening paragraph, the record carrier comprising spiral angle information, and the method comprising detecting a spiral angle between the first data layer and the second data layer, the spiral angle indicating an actual rotational angle between a first predetermined location on the first data layer and a second predetermined location on the second data layer, and combining the spiral angle information and the spiral angle for controlling said providing of information.

According to a second aspect of the invention the object is achieved with a multilayer record carrier as described in the opening paragraph, the record comprising spiral angle information, which spiral angle information is to be combined with a spiral angle for controlling said providing of information, the spiral angle indicating an actual rotational angle between a first predetermined location on the first data layer and a second predetermined location on the second data layer.

According to a third aspect of the invention the object is achieved with a scanning device as described in the opening paragraph, the device comprising a control unit for detecting a spiral angle between the first data layer and the second data layer, the spiral angle indicating an actual rotational angle between a first predetermined location on the first data layer and a second predetermined location on the second data layer

The predetermined locations are reference points for defining the rotational angle between spirals on the data layers, and may be included in the spiral angle information or prescribed in a standard, e.g. address zero on each data layer. The spiral angle information indicates to the device that a spiral angle is to be detected. The spiral angle information may be a digital code indicating a specific spiral angle that should be present, or indicate a control code or control process to be applied for verifying the spiral angle. The spiral angle information may be embedded in a software program that may execute the measurement of the spiral angle or that may respond in a specific way on a spiral angle detected.

The effect of the measures is that the detected spiral angle is combined with the spiral angle information, i.e. the angle is determined, verified and/or applied based on the prerecorded spiral angle information, and the result of the combining is used to control the flow of information to the user. The result provides a parameter to identify the record carrier, and affect the providing of information to the user. For example the user may get access to parts or all of the information that is present on the record carrier, if the spiral angle corresponds to the spiral angle information. Advantageously detecting the spiral angle does not require additional detection circuits for detecting deviating properties of the scanning signal.

The invention is also based on the following recognition. Various access control schemes are known which are based on modulating physical parameters of the record carrier. Although such schemes may be difficult to mimic during illegal copying, such schemes also increase the cost of manufacture of the record carrier. The inventors have seen that the rotational orientation of different data layers in a multilayer record carrier provides a verifiable parameter of a record carrier which cannot be mimicked. The parameter may surprisingly be used even without modulating or controlling the manufacturing process.

Note that the orientation of the spiral on different layers on a recordable type of record carrier cannot be influenced, and is based on preformed track patterns that include positional information like addresses. Hence an illegal copy on a recordable record carrier will not have the same spiral angle as the original record carrier. The spiral angle of the original record carrier, in combination with appropriate spiral angle information on that record carrier, can be applied in various ways to control the access or use of information on the record carrier.

In an embodiment of the method said combining the spiral angle information and the spiral angle for controlling said providing of information includes providing different versions of the information in dependence of the spiral angle via a spiral angle dependent function that constitutes the spiral angle information. This has the advantage that the user experiences having a unique record carrier. For example the spiral angle is used as a disc identifier applied during predefined functions of software included on the record carrier, e.g. during games for providing different versions of a single game, or registering his record carrier for receiving support or updates.

In an embodiment of the method said combining the spiral angle information and the spiral angle for controlling said providing of information includes refusing or enabling access to the information in dependence of the spiral angle, the spiral angle information indicating a required spiral angle. During manufacture of the record carrier the spiral angle as required may be applied by controlling the orientation of the data layers, e.g. by controlling manufacturing subunits that generate data layers. Alternatively the spiral angle information may be applied after measuring the actual rotational angle, e.g. by recording data in some recordable part of a data layer, or by writing a barcode on the record carrier in a central area.

In an embodiment of the method said combining the spiral angle information and the spiral angle for controlling said providing of information includes retrieving a code parameter from the record carrier such as a barcode or a key code and include the code parameter in said combining, the spiral angle information, the spiral angle and/or the code parameter being related via an algorithm. The spiral angle information is part of the data included on the data layer as applied via a master record carrier, e.g. by stamping. During manufacture the actual rotational angle is measured and the code parameter is calculated and stored on the record carrier. This has the advantage that the algorithm, which is known to the manufacturer, provides additional protection against tampering with the data.

In an embodiment of the method said combining the spiral angle information and the spiral angle for controlling said providing of information includes requesting a user code to be entered by a user and include the user code in said combining, the spiral angle information, the spiral angle and/or the user code being related via an algorithm. The spiral angle information is part of the data included on the data layer as applied via a master record carrier, e.g. by stamping. During manufacture the actual rotational angle is measured and the user code is calculated. The user code may be transferred separately to the user to increase safety, or to have the user register or access a website. In addition the algorithm may provide additional protection against tampering with the data.

In an embodiment of the method the spiral angle information comprises accurate spiral parameter information, and said detecting comprises detecting a selected location on the first or second data layer and subsequently deriving the position of the first or second predetermined location based on the accurate spiral parameter information.

In an embodiment of the record carrier the spiral angle information comprises accurate spiral parameter information for deriving the position of the first or second predetermined location based on a selected location and the accurate spiral parameter information.

The inventors have seen that current mastering processes for creating the spiral may be surprisingly accurate, resulting in a high precision spiral, which is determined by spiral parameters like track pitch and data bit length. Assuming that accurate spiral parameters are known to the device the spiral angle may be detected by accessing an arbitrarily selected location on each data layer, and subsequently calculating the spiral orientation of the predetermined reference points. The spiral parameters may be detected in the device by a number of measurements on various locations on the respective spiral. However, advantageously, accurate spiral parameters may be included in the spiral angle information. It is to be noted that such spiral parameters need to have sufficient resolution and accuracy to calculate the physical shape of the spiral and the exact position of physical addresses in the spiral, for example 8 decimal digits.

In an embodiment of the method said detecting comprises determining the spiral angle as a value within a predetermined and discrete range of actual rotational angle values. In practical circumstances the accuracy of detecting the actual rotational value is limited. The discrete range advantageously results in a predefined and predictable value. In a particular case an embodiment of the method includes indicating a main value, a main value and a possible next lower value or a main value and a possible next higher value, and said combining includes, after combing the main value, subsequently combining the possible next spiral angle values. It is noted that the actual rotational angle may have any value, in particular if no control during manufacture is applied. Hence borderline cases may, e.g. due to inaccuracies of detection in various devices, result in different discrete values. Including the possible neighboring values has the advantage that if during said detecting the neighboring rotational value is found, such value may still be accepted in a predictable way.

In an embodiment of the method said detecting comprises including in the spiral angle an additional angle between the first data layer and the second data layer, the additional angle indicating an additional actual rotational angle between a first additional predetermined location on the first data layer and a second additional predetermined location on the second data layer, said additional locations being different from the first predetermined location and the second predetermined location. The inventors have noted that the number of properly distinguishable spiral angles will be limited by accuracy of detection. The effect of including the additional angle in the spiral angle is that the amount of properly distinguishable spiral angles is significantly increased. It is noted that the spiral parameters that determine the position of the additional predetermined locations on the various data layers of the record carrier are fixed by the masters used for manufacturing, and therefore the relation between actual rotational angles is also fixed. Such spiral parameters include the track pitch and data bit length, which are not transferred as accurate values to the device in this embodiment. Note that the spiral parameters may even be (slightly) manipulated during mastering to increase the difficulty of mimicking the locations of both the predetermined and the additional predetermined locations. Hence, in an illegal copy, not only it would be required make both data layers to have the required orientation, but also the spiral parameters would need to be accurately controlled.

Further preferred embodiments according to the invention are given in the appended claims, disclosure of which is incorporated herein by reference.

These and other aspects of the invention will be apparent from and elucidated further with reference to the embodiments described by way of example in the following description and with reference to the accompanying drawings, in which

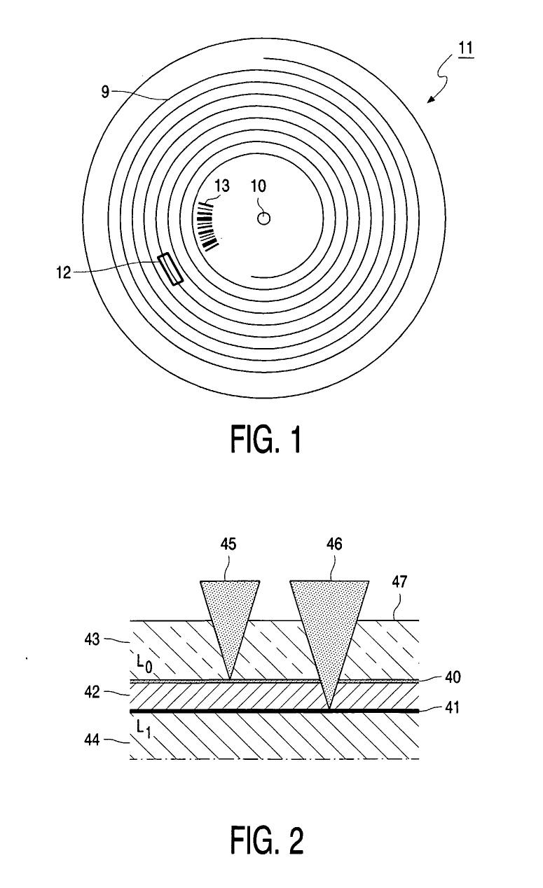

FIG. 1 shows a disc-shaped record carrier having spiral angle information,

FIG. 2 shows a multilayer optical disc,

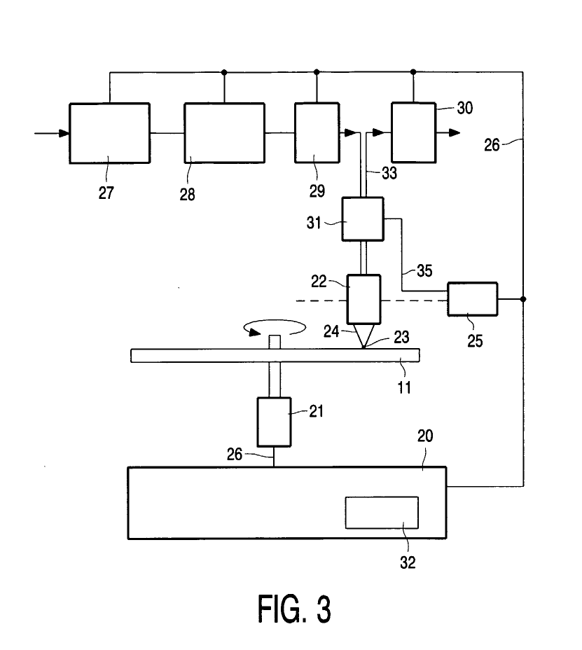

FIG. 3 shows a scanning device having spiral angle information control,

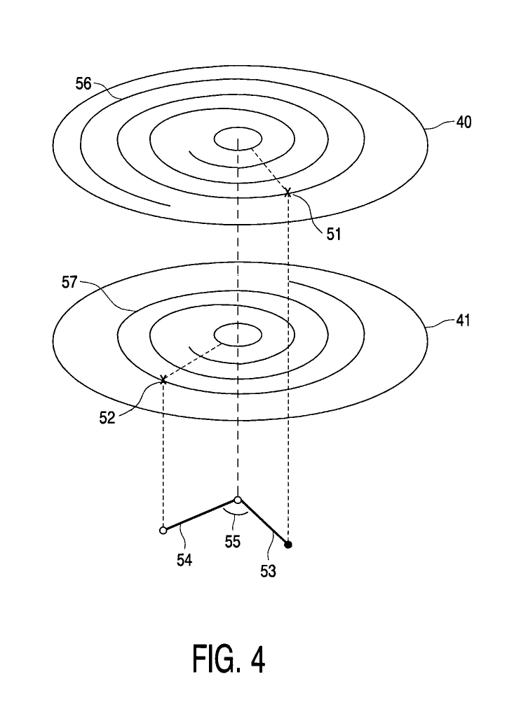

FIG. 4 shows determining an actual rotational angle between spirals, and

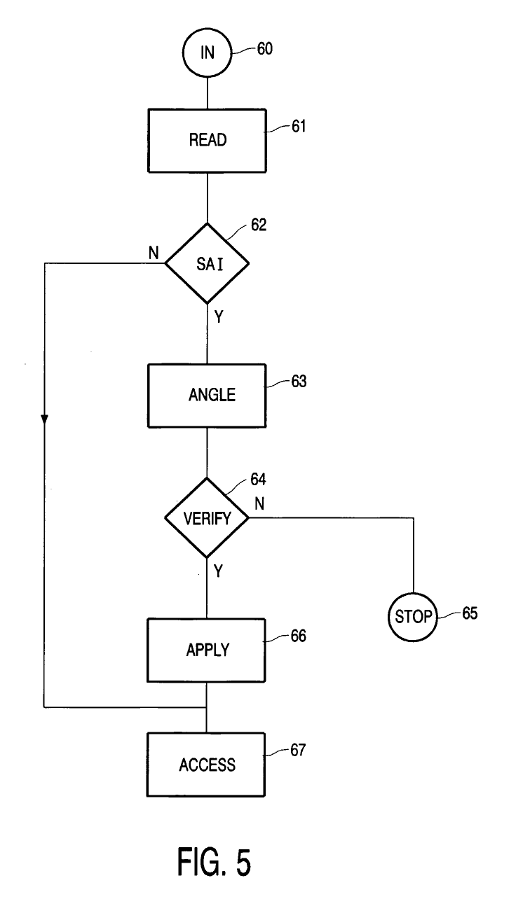

FIG. 5 shows a process for applying spiral angle information for controlling access to or the function of content on a record carrier.

In the Figures, elements which correspond to elements already described have the same reference numerals.

FIG. 1 shows a disc-shaped record carrier 11 having spiral angle information. A track 9 is arranged in accordance with a spiral pattern of turns around a central hole 10 constituting substantially parallel tracks on a data layer. The record carrier has at least two data layers, as shown in FIG. 2. The data layers contain information represented by marks in the tracks, e.g. manufactured by stamping. The marks are to be scanned by a beam of radiation, usually a laser beam. The marks are constituted by variations of a physical parameter and thereby have different optical properties than their surroundings, e.g. in the form of areas with a reflection coefficient different from their surroundings. During reading the marks are detectable by variations in the reflected beam, e.g. variations in reflection. The record carrier may be intended to carry real-time information, for example video or audio information, or other information, such as computer data.

The record carrier may be an optical disc of a recordable type, for example a DVD+RW or DVD+R, or a DVD-RW or DVD-R. The track 9 is indicated by a pre-track structure provided during manufacture of the blank record carrier, for example a pregroove, which enables a read/write head to follow the track 9 during scanning. The pregroove may be implemented as an indentation or an elevation, or may consist of a material having a different optical property than the material of the pregroove. The pre-track structure may also be formed by regularly spread sub-tracks or pre-pits which periodically cause servo signals to occur. During recording the marks are created in materials such as dye, alloy or phase change material, or in the form of areas with a direction of polarization different from their surroundings, obtained when recording in magneto-optical material.

According to the invention the record carrier is a multilayer record carrier provided with spiral angle information. In FIG. 1 spiral angle information 12 shows a first embodiment wherein the spiral angle information is located in the tracks, e.g. on a predefined position or address, or in a file. The spiral angle information is to be verified to an actual rotational angle between the spirals on both data layers, explained below with FIGS. 4 and 5, before accessing further data or during processing data or software content from the record carrier. The spiral angle information 12 may be an amount of digital data indicating a spiral angle, e.g. as part of a control file, a dedicated file, or on a predefined location as prescribed by a standard recording format.

In an embodiment the spiral angle information 12 is encoded in the pre-track structure, e.g. by a modulation of the wobble of the pregroove. On a recordable type of record carrier the combination of the spiral angle information and a particular actual rotational angle provides a system of controlling data recorded on a recordable type of record carrier. Additionally spiral angle information may be recorded in a secret location, and/or may be calculated using a cryptographic algorithm only known to the owner of the information to be protected. A suitable verification process may, for example, be applied based on public keys.

In an embodiment the spiral angle information is embedded in a software program to be executed on a host computer. When executed, the program will require a reading device to retrieve an actual rotational angle from the record carrier as explained below, and apply the value acquired to control the function of the program. The basic idea is to use the measured actual rotational angle value to change the behavior of the content that is stored on the record carrier. Thereby it is possible to mass manufacture a record carrier that nevertheless exhibits several variants, while only requiring a single master (usually called image). For example, for a game on the record carrier, the game runs differently depending on the measured value. It may have a different starting condition, show a different intro movie, provide a different role for the player (in a role playing game), change or add levels, etc. Note that a somewhat similar behavior may be generated via a random function, which would however result in a different game each time it is started. By using the actual spiral angle value, the game would always be the same if run from the particular disc, but different if started from a different disc. This may be used to create an urge to get several discs, or even collect all variants of a disc. Alternatively, a single disc may be included with other merchandise or distributed as a promotional item, and still provide a large number of different features, in order to stimulate the sales of other objects.

In FIG. 1 a spiral angle information barcode 13 shows a second embodiment of the spiral angle information. The barcode is located outside the usual area for data tracks, e.g. on a predefined radial position. For example, the DVD standard already provides an area for adding a central area barcode. As usual for such central area barcodes the spiral angle information barcode may be read using the beam of radiation that is also used for reading marks from the tracks. The spiral angle information barcode 13 may be used as an alternative, or in combination with the spiral angle information 12, and may reflect an actual rotational value measured before writing the barcode.

FIG. 2 shows a multilayer optical disc. L0 is a first data layer 40 and L1 is a second data layer 41. A first transparent layer 43 covers the first data layer, a spacer layer 42 separates both data layers 40,41 and a substrate layer 44 is shown below the second data layer 41. The first (or upper) data layer 40 is located at a position closer to an entrance face 47 of the record carrier than the second (or lower) data layer 41. A laser beam is shown in a first state 45 focused on the L0 layer and the laser beam is shown in a second state 46 focused at the L1 layer. Writable and rewritable optical storage media having 3 or more data layers are considered also.

FIG. 3 shows a scanning device having spiral angle information control. The device is provided with scanning means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head may contain all optical elements, the laser and detectors as an integrated unit, usually called Optical Pickup Unit (OPU), or may contain as a movable unit only some of the optical elements, while the remaining optical elements and laser and detector are located in a unit on a fixed mechanical location, usually called split-optics, the beam being transferred between both units, e.g. via a mirror. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information.

The control unit 20 controls the scanning and retrieving of information and may be arranged for receiving commands from a user or from a host computer. The control unit 20 is connected via control lines 26, e.g. a system bus, to the other units in the device including the motor 21 to control the rotation of the record carrier. The control unit 20 comprises control circuitry, for example a microprocessor, a program memory and interfaces for performing the procedures and functions as described below. The control unit 20 may also be implemented as a state machine in logic circuits.

In an embodiment the device is provided with recording means for recording information on a record carrier of a writable or re-writable type. The recording means include an input unit 27, a formatter 28, a laser unit 29, front-end unit 31 and the head 22 for generating a write beam of radiation. The formatter 28 is for adding control data and formatting and encoding the data according to the recording format, e.g. by adding error correction codes (ECC), synchronizing patterns, interleaving and channel coding. The formatted units comprise address information and are written to corresponding addressable locations on the record carrier under the control of control unit 20. The formatted data from the output of the formatter 28 is passed to the laser unit 29 which controls the laser power for writing the marks in a selected recording layer.

In an embodiment real-time information from a source device is presented on the input unit 27 that may comprise compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to units of information, which are passed to the formatter 28. The read processing unit 30 may comprise suitable audio and/or video decoding units.

According to the invention the control unit 20 includes an angle unit 32 for detecting an actual rotational angle based on selected locations as described below with reference to FIG. 4. Detecting the actual rotational angle may be implemented by first moving the beam to a first selected location in a first data layer of the record carrier and, after detecting the presence thereof, making a layer jump to a second data layer, and detecting a second selected location of the beam on the second layer, e.g. by reading an address. The relative angular position of the second selected location can be easily calculated knowing the rotation rate of the record carrier and time difference of both detected locations. Alternative to time measurements the amount of rotation of the record carrier may be monitored directly, e.g. from control signals to the motor 21 that rotates the record carrier. Such control signals are commonly controlled, or at least available, in the control unit.

In an embodiment the device is a storage system only, e.g. an optical disc drive for use in a computer. The control unit 20 is then arranged to communicate with a processing unit in the host computer system via a standardized interface. It is noted that the process of detecting the spiral angle may be performed in the device or in the host by a dedicated software program, i.e. via a standard disc drive. For example detecting the spiral angle via time differences described as a function of the angle unit 32 in the device may be implemented by said software program.

In an embodiment the control unit 20 is arranged for controlling the retrieval and/or function of the information in dependence of the spiral angle and spiral angle information as described below with reference to FIG. 5. Alternatively the functions for controlling the retrieval and/or function of the information in dependence of the spiral angle information may partly be performed in a different processing unit, e.g. in a host computer via a software driver, or via an application software program provided on a data carrier or via a network such as the internet.

In an embodiment the device is arranged as a stand alone unit, for example a video recording apparatus for consumer use. The control unit 20, or an additional host-like control unit included in the device, is arranged to be controlled directly by the user, and to perform the functions of the file management system.

FIG. 4 shows determining an actual rotational angle between spirals. A first data layer 40 has a first spiral 56, and a first predetermined location 51 on the first data layer 40. A second data layer 41 has a second spiral 57, and a second predetermined location 52 on the second data layer 41. The predetermined locations 51,52 provide reference points for defining the spiral angle, and may for example be predetermined addresses, or specific synchronization fields. In an embodiment the predetermined locations are located at a predefined radial position, and an address or other position data is retrieved at the predefined radial position on both layers. The first predetermined location 51 is detected to be located at a first angular position 53. The second predetermined location 52 is detected to be located at a second angular position 54. The difference in both angular positions 53,54 indicates the actual rotational angle between the first predetermined location 51 on the first data layer 40 and a second predetermined location 52 on the second data layer 41.

It is noted that the predetermined locations 51,52, i.e. the reference points for defining the spiral angle, may be actually accessed themselves, e.g. data blocks at the physical addresses of the predetermined locations are read. In an embodiment spiral parameters such as track pitch and data bit length are used to calculate the position of the predetermined locations based on accessing an arbitrarily selected location near the predetermined locations. In a particular embodiment accurate spiral parameters may be included in the spiral angle information on the record carrier, and the record carrier has an accurately shaped spiral. The arbitrary selected location may then be any location on the record carrier, and calculation from any selected location and the accurate spiral parameters will result in substantially the same position of the predetermined location. The device may even access a number of selected locations on various radial positions and calculate the corresponding positions of the predetermined location, and subsequently take the average to increase accuracy of the detected actual spiral angle, or monitor a variance or spread to detect an illegal copy that does not have the accurate spiral shape which is present on the original disc. For the explanation of detecting the spiral angle the words selected location are used, which locations can either be the predetermined locations or can be any accessed locations used, in combination with spiral parameters, to calculate the position of the predetermined locations.

In the device as describe above with reference to FIG. 3 the angle unit 32 is arranged for detecting the spiral angle between the first data layer and the second data layer as follows. In an embodiment the angle unit is coupled to drive signals that control or monitor the motor 21, for example a tachometer signal indicating the rotation of the motor or a periodic drive signal for a synchronous motor. From the drive signal the angle unit determines the rotational position of the motor at the moments the first and second selected locations are detected. Alternatively the rotational speed or rotation time is known or detected first, and secondly a time difference is accurately measured between detecting the first and second selected location. The rotation time may be measured accurately by measuring the time between successively reading a selected address twice. It is noted that a layer jump between the first and second layer is required between both measurements, which may take longer than a single rotation time. For calculating the actual rotational angle 55 the time difference (as measured) is taken modulo the rotation time, and the remaining fraction is divided by the rotation time to find the actual rotational angle 55.

In an embodiment the angle unit 32 is arranged for determining the spiral angle as a value within a predetermined and discrete range of actual rotational angle values. In practical circumstances the accuracy of detecting the actual rotational value is limited. The discrete range may be predetermined and the steps in the range are set in view of the accuracy, e.g. 5× the average accuracy. In a further embodiment the angle unit 32 is arranged for determining the spiral angle and also for indicating optional values as follows. The optional values are indicated if the measure angle is close to a boundary of a range of values assigned to a step. First a most likely main value within the predetermined and discrete range of actual rotational angle values is detected. The measured value may be close to the boundary of the step. If the main value is in the central area of the step, e.g. the central 50% area, only the main value is indicated. However, if the measured angle is in the lower 25% of the step range, a main value and a possible next lower value are indicated, and if the measured angle is in the upper 25% of the step range, a main value and a possible next higher value are indicated. It is noted that the steps may also be considered to have overlapping areas, and two steps being indicated if the measured value is within such overlap. The verification of the spiral angle information with the actual rotational angle starts with combining the main value, but includes, after combing the main value, subsequently combining the possible next spiral angle values.

In an embodiment the angle unit 32 is arranged for including in the spiral angle an additional angle between the first data layer and the second data layer. The spiral angle then contains at least two values including the additional angle indicating an additional actual rotational angle between a first additional predetermined location on the first data layer and a second additional predetermined location on the second data layer. The additional locations are different from the first predetermined location 51 and the second predetermined location 52, for example the first and second predetermined locations are located at an outer radial position, while the first and second additional predetermined locations are located at an inner radial position. The additional rotational angle is measured by the same method as the actual rotational angle 55. Note that including additional predetermined locations as parameters of the spiral angle assumes that the spiral parameters are not highly accurate, or at least not accurately known to the device As explained above known accurate spiral parameters would allow calculation of the main reference points (predetermined locations) from any further location on the record carrier, and additional reference points and measurements would be redundant.

FIG. 5 shows a process for applying spiral angle information for controlling access to or the function of content on a record carrier. In a first step IN 60 a record carrier is entered in a device for accessing data. In a next step READ 61 the device retrieves spiral angle information. It is noted that the presence of spiral angle information may be known from the type of the record carrier, or the device may be designed to always look for spiral angle information. The spiral angle information may also be retrieved as part of content or software read from the record carrier under command of the user, e.g. via a host computer. In a step SAI 62 the presence of spiral angle information may be detected, and if no spiral angle information is available the drive accepts the record carrier as not requiring access control and proceeds with accessing the record carrier in step ACCESS 67. If spiral angle information is present, the actual rotational angle is detected in step ANGLE 63, and presented as the spiral angle. In a next step VERIFY 64 the spiral angle and the spiral angle information are combined and verification is performed. Several options for using the result of the verification are given, including refusing to further access the record carrier of no match is found in step STOP 65. If a match is found, the spiral angle is applied as appropriate in step APPLY 66, which step may include a further check of a user code or a record carrier code as explained below. Finally, if the spiral angle information and spiral angle are verified and checks are OK, the user may access the record carrier or use the software from the record carrier as intended in step ACCESS 67.

In an embodiment of the process in step VERIFY 64 said combining the spiral angle information and the spiral angle for controlling said providing of information includes refusing or enabling access to the information in dependence of the spiral angle. The spiral angle information may indicate a predefined spiral angle. During manufacture of the record carrier the predefined angle is applied by controlling the orientation of the data layers. Alternatively the spiral angle information may be applied after measuring the actual rotational angle after manufacture, e.g. by recording data in some recordable part of a data layer, or by writing a spiral angle information barcode 13 on the record carrier in a central area as shown in FIG. 1.

In an embodiment of the process in step APPLY 66 combining the spiral angle information and the spiral angle for controlling said providing of information includes retrieving a code parameter from the record carrier. The code parameter may be a barcode or a key code which is additionally recorded on the record carrier. The code parameter is included in the calculation of said combining, and the spiral angle information, the spiral angle and/or the code parameter are related via an algorithm, e.g. a cryptographic one-way function. The spiral angle information is part of the data included on the data layer as applied via a master record carrier, e.g. by stamping. During manufacture the actual rotational angle is measured and the code parameter is calculated and stored on the record carrier. This has the advantage that the algorithm, which is known to the owner of the content, provides additional protection against tampering with the data.

In an embodiment of the process, in particular in steps VERIFY 64 and APPLY 66, a program embedding the spiral angle information is distributed on the record carrier and requires the user to enter a user code. The program may alternatively be distributed via a network like internet, and the spiral angle information may be included on the record carrier. The user code may be transferred separately to the user to increase safety, or to have the user register or access a website. The user may acquire the user code from an official license document, or from a website, etc. The user code is compared to the actual rotational angle. In particular the embedded spiral angle information may be combined with the actual rotational angle value and the user code in an algorithmic calculation, the elements having a predefined algorithmic relation. For example well known cryptographical techniques may be applied to generate the user code, and, at the user's location, to verify the user code. The spiral angle information is part of the data included on the data layer as applied via a master record carrier, e.g. by stamping. During manufacture, before distribution or on request of the user, the actual rotational angle is measured and the user code is calculated. The actual angle may also be measured on the user's device, and an angle code be subsequently generated, and the user may be asked to first enter the angle code before receiving the user code.

Although the invention has been mainly explained by embodiments using dual layer optical discs having spiral shaped tracks, the invention is also suitable for other record carriers such as rectangular optical cards, magneto-optical discs, or any other type of information storage system that has at least two independent data layers in an arbitrary alignment. Hence the word spiral in this document also includes annular shaped or linear track patterns, and rotational angle includes any measure of such alignment. In addition, in a multilayer record carrier having 3 or more data layers, the alignment between more than two data layers may be taken into account.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Method of providing information via a multilayer record carrier, the record carrier comprising at least a first data layer (40) and a second data layer (41) and spiral angle information,
the method comprising
detecting a spiral angle between the first data layer and the second data layer, the spiral angle indicating an actual rotational angle between a first predetermined location on the first data layer and a second predetermined location on the second data layer, and
combining the spiral angle information and the spiral angle for controlling said providing of information.

2. Method as claimed in claim 1, wherein said combining the spiral angle information and the spiral angle for controlling said providing of information includes at least one of the following:
providing different versions of the information in dependence of the spiral angle via a spiral angle dependent function that constitutes the spiral angle information;
refusing or enabling access to the information in dependence of the spiral angle, the spiral angle information indicating a required spiral angle;
retrieving a code parameter from the record carrier and include the code parameter in said combining, the spiral angle information, the spiral angle and/or the code parameter being related via an algorithm;
requesting a user code to be entered by a user and include the user code in said combining, the spiral angle information, the spiral angle and/or the user code being related via an algorithm.

3. Method as claimed in claim 1, wherein the spiral angle information comprises accurate spiral parameter information, and said detecting comprises detecting a selected location on the first or second data layer and subsequently deriving the position of the first or second predetermined location based on the accurate spiral parameter information.

4. Method as claimed in claim 1, wherein said detecting comprises determining the spiral angle as a value within a predetermined and discrete range of actual rotational angle values, in a particular case including indicating a main value, a main value and a possible next lower value or a main value and a possible next higher value, and said combining including, after combing the main value, subsequently combining the possible next spiral angle values.

5. Method as claimed in claim 1, wherein said detecting comprises including in the spiral angle an additional angle between the first data layer and the second data layer, the additional angle indicating an additional actual rotational angle between a first additional predetermined location on the first data layer and a second additional predetermined location on the second data layer, said additional locations being different from the first predetermined location and the second predetermined location.

6. Computer program product for providing information, which program is operative to cause a processor to perform the method as claimed in claim 1.

7. Multilayer record carrier for providing information, the record carrier comprising at least a first data layer (40) and a second data layer (41) and spiral angle information,
which spiral angle information is to be combined with a spiral angle for controlling said providing of information, the spiral angle indicating an actual rotational angle between a first predetermined location on the first data layer and a second predetermined location on the second data layer.

8. Record carrier as claimed in claim 7, wherein the first data layer (40) and the second data layer (41) are positioned at an angular position corresponding to the spiral angle information.

9. Record carrier as claimed in claim 7, wherein the spiral angle information comprises accurate spiral parameter information for deriving the position of the first or second predetermined location based on a selected location and the accurate spiral parameter information.

10. Record carrier as claimed in claim 7, wherein the record carrier comprises the computer program as claimed in claim 6.

11. Device for scanning a record carrier via a beam of radiation for use in the method of providing information as claimed in claim 1,
the record carrier comprising at least a first data layer (40) and a second data layer (41) and spiral angle information,
the device comprising,
scanning means for recording and/or retrieving the information, which scanning means include a head (22) for providing the beam of radiation, and
a control unit (20,32) for detecting a spiral angle between the first data layer and the second data layer, the spiral angle indicating an actual rotational angle between a first predetermined location on the first data layer and a second predetermined location on the second data layer.

12. Device as claimed in claim 11, wherein the control unit (20,32) is arranged for combining the spiral angle information and the spiral angle for controlling said providing of information.
